(19) United States
(12) Patent Application Publication
(10) Pub. No.: US 2007/0181651 A1
(43) Pub. Date: Aug. 9, 2007

(54) Method for setting capillary contact position data and wire bonding apparatus using the same

(75) Inventors: Kuniyuki Takahashi, Musashimurayama-shi (JP); Satoshi Enokido, Hachioji-shi (JP)

Correspondence Address: KODA & ANDROLIA, 2029 CENTURY PARK EAST, SUITE 1140, LOS ANGELES, CA, 90067, US

(73) Assignee: Kabushiki Kaisha Shinkawa

(21) Appl. No.: 11/704,578

(22) Filed: Feb. 9, 2007

(30) Foreign Application Priority Data
Feb. 9, 2006 (JP) 2006-032322

(51) Int. Cl. A47J 36/02

(52) U.S. Cl. 228/101

(57) ABSTRACT

In wire bonding, a clearance measurement between the capillary and reference member being performed by an image capturing device for capturing elevation images of the used and new (replaced) capillaries and the reference member and by a clearance measuring device that processes the elevation images of the capillaries and the reference member, obtained by the image capturing device, and then measures the distance in a vertical direction between the tip ends of the capillaries and the tip end of the reference member, thus setting post-replacement capillary contact position data based on pre-replacement capillary contact position data and the obtained clearance difference.

### BACKGROUND OF THE INVENTION

The present invention relates to a method and apparatus for setting capillary contact position data that is used when replacing capillaries in a wire bonding apparatus.

In assembling semiconductors such as ICs (integrated circuits), there is a wire bonding process for making connections between a semiconductor chip and a lead frame with wires. With such a wire bonding, as shown in FIG. 4, connections by wires 12 are made between pads 3 (first bonding points) on a semiconductor chip 2 of a work 15 and leads 4 (second bonding points) on a lead frame 15.

FIG. 3(a) and FIG. 3(b) illustrate the configuration of a conventional wire bonding apparatus, and FIG. 5 shows bonding process actions performed in this wire bonding apparatus. The conventional wire bonding apparatus and wire bonding process will be described below with reference to FIGS. 3(a), 3(b) and FIG. 5.

In the wire bonding apparatus 10, as disclosed in, for instance, Japanese Utility Model Application Laid-Open Disclosure No. 2003-163243 and as shown in FIG. 3(a), a bonding head 19 is provided on an XY table 20, and a bonding arm 13 which is movable in Z (vertical) direction by a motor (not shown) is provided on the bonding head 19. A capillary 16 is attached to the tip end of the bonding arm 13. The XY table 20, movable in XY (horizontal) directions, and bonding head 19 form a moving mechanism 18. The moving mechanism 18 moves, by the XY table 20, the bonding head 19 to any position on a horizontal plane (XY plane), and, by way of moving the bonding arm 13 attached thereto in the Z direction, the moving mechanism 18 moves the capillary 16 at the tip of the bonding arm 13 freely in all X, Y and Z directions. The bonding wire (“wire”) 12 wound on a spool 11 is released, and it passes through the tip end of the bonding arm 13. A clamper 17 which opens and closes is attached to the bonding head 19 so that it is moved in X, Y and Z directions together with the capillary 16 to secure the wire 12. A ball formation device 26 (an electric torch) for effecting electric discharges between itself and the wire 12 to form the tip end of the wire 12 into a ball is provided so that it is in the vicinity of the tip end of the wire 12.

Moreover, to the bonding head 19, an image capturing device 28 for capturing images of the work on which bonding is performed is attached. In addition, a light path device 24, for conducting elevation images of the vicinity of the tip end of the capillary 16 to the image capturing device 28, is mounted on a base plate 23 which is provided in an elevation image capturing position; and the image capturing device 28 obtains elevation images of the capillary 16 and a reference member 25, via the light path device 24. The light path device 24 is configured, as seen from FIG. 3(b), so that the tip part of the capillary 16, together with the reference member 25, is illuminated by a light emitter 21 such as a light emitting diode, from the side surface of the capillary 16, and so that the elevation images formed are conducted by a lens 24a and prism 24b to the image capturing device 28. The image capturing device 28 is connected to an image capturing device interface 40, while the moving mechanism 18 is connected to a moving mechanism interface 44. The interfaces 40 and 44 are connected via a data bus 32 to a control section 30 that controls the bonding actions. To the data bus 32, moreover, a memory unit 34 where data on bonding are stored is connected.

In this wire bonding apparatus 10, wire bonding is performed with such steps as described below:

(1) As seen from FIG. 5(a), the tip end of the wire 12 is formed into a ball 5, and the capillary 16 is (with the damper 17) moved to be over the pad 3 (first bonding point).

(2) The capillary 16 is (with the damper 17) made to descend, and bonding is performed on the pad 3 (first bonding point) (FIG. 5(b)). In other words, onto the pad 3 (first bonding point), the ball 5 is pressure-bonded, and a first bond 6 (pressure-bonded ball) is thus formed.

(3) After bonding on the pad 3, the capillary 16 is (with the damper 17) made to ascend and moved away from the pad 3 (first bonding point), and then is moved (with the damper 17) laterally (FIG. 5(c)).

(4) After completion of bonding to the pad 3 (first bonding point), as seen from FIG. 5(d), the capillary 16 is (with the damper 17) moved to a lead 4 (second bonding point), and bonding of the wire is performed at the lead 4 (second bonding point).

(5) After bonding to the lead 4 (second bonding point), the capillary 16 is (FIG. 5(d)) made to ascend with the damper 17 opened (FIG. 5(e)).

(6) After completion of bonding to the lead 4 (second bonding point), the damper 17 is closed and is made to ascend together with the capillary 16. As a result, the wire 12 is cut above a second bond 7 on the lead 4 (such cutting called “tail cutting”). One bonding cycle thus ends (FIG. 5(f)).

The wire bonding apparatus performs bonding by way of repeating the bonding cycle as described above. However, as the execution number of bonding becomes larger, foreign matters would accumulate on, for instance, the capillary. In other words, as seen from illustration (c) of FIG. 6, foreign matters 29 to which, for example, silver from the lead (4) stick would begin to adhere to a chamfered portion 16b on the inside of the capillary 16 shown in illustration (b) of FIG. 6((b) being an enlarged cross-sectional illustration of a circled portion of illustration (a) of FIG. 6); and as a result, bonding anomalies, such as poor tail cutting, begin to occur. As a result, it is inevitable to replace the capillary after a certain number of bonding actions, such as once every one million times. In actuality, with an ordinary wire bonding apparatus, it is necessary to execute capillary replacement two or three times a day.

Conventional capillary replacement is accomplished as shown in FIG. 7, and it is done by the procedures of manual unfastening of the old or used capillary, replacement of it with a new or unused capillary, and re-securing of the new or replaced capillary. As described above regarding the configuration of the bonding apparatus of FIG. 3(a) and the bonding procedures of FIG. 5, the capillary 16 is attached to the tip end of the bonding arm 18, and it presses against the first bonding point (pad) 3 and then the second bonding point (lead) 4; in other words, the bonding apparatus contains, as control data, data on how far the capillary 16 must descend by the bonding arm 13 so that the tip end of the capillary 16c comes into contact with the bonding points, and the precision thereof is very important from the perspective of securing high bonding quality. However, displacement would develop for capillary movements when capillaries are replaced; accordingly, in the conventional wire bonding apparatus 10, after the capillary 16 is replaced, the bonding arm 13 is moved from a predetermined position until the tip end of the capillary 16 come into contact with the second bonding point (lead) 4, and the distance (distance D shown in FIG. 8) of movement, from the predetermined position until the tip end of the capillary 16 contacts the second bonding point (lead) 4, is obtained as capillary contact position data, each time the capillary is replaced, and further the data in the control section are replaced with a newly obtained capillary contact position data so as to secure the precision of the bonding action. The conventional procedures for replacing capillaries will be described below with reference to FIG. 7.

(1) First, in order to execute capillary replacement, the bonding head 19 is moved to a position of refuge by the moving mechanism 18 (steps S201 and S202 in FIG. 7).

(2) A capillary removal tool 50 is inserted into a capillary removal tool insertion hole 13b at the tip part of the bonding arm 13 as shown in FIG. 7(b), and the tool 50 is turned, so that the old, used capillary 16 held in the capillary holding hole 13a is removed by (operator's) hand (step S203, FIG. 7(b)).

(3) A replacement (new) capillary 16′ is pushed into the capillary holding hole 13a, and the capillary removal tool 50 is turned, so that the new capillary 16′ is temporarily secured (step S204, FIG. 7(c)).

(4) A capillary height setting tool 52 is set at the tip end of the capillary 16′, the capillary 16′ is loosened by the capillary removal tool 50, the tip of the capillary 16′ is brought up against the capillary height setting tool 52, and the position of the capillary 16′ is adjusted, after which the capillary removal tool 50 is turned, so that the capillary 16′ is secured in the capillary holding hole 13a of the bonding arm 13 (steps S205 to S208, FIG. 7(d) to 7(f)).

(5) The bonding arm 13 having the new the capillary 16′ is moved so that the capillary 16′ is made to descend, until the tip end of the capillary 16′ contacts the second bonding point (lead) 4 (step S209, FIG. 7(g)).

(6) When the tip end of the capillary 16′ comes into contact with the second bonding point (lead) 4, the action of the bonding arm 13 is stopped, and the distance of descending movement at that time is obtained as capillary contact position data (step S210, FIG. 7(h)). Based thereon, the capillary contact position data stored in the bonding control section are revised.

(7) The (position of the) capillary 16′ is moved to the elevation image capturing position, where the light path device 24 is provided, and an elevation image of the reference member 25 and the tip end part of the replaced capillary 16′ is obtained by the image capturing device 28, and the displacement in the position in the XY (horizontal) directions of the replaced capillary 16′ is measured. Based thereon, the XY-direction position data in the bonding control section are revised (steps S211 to S214, FIG. 7(i)).

(8) The capillary replacement is thus completed, and bonding is resumed (steps S215 and S216).

As described above, when replacing (exchanging) the capillary 16 with a new capillary 16′, it is necessary to bring the new capillary 16′ to come into contact with the second bonding point (lead) 4 and manually verify the capillary contacting position to the second bonding point. Thus, it requires several minutes of time even for such an ancillary job. Ordinarily, several tens of wire bonding apparatuses are installed and operated simultaneously; and since the capillary replacement must be performed three times or so a day, enormous maintenance time is required in the conventional capillary replacement. That has been a problem.

### BRIEF SUMMARY OF THE INVENTION

Accordingly, an object of the present invention is to shorten the length of time period required for capillary replacement and to secure laborsaving on maintenance of bonding apparatuses.

The above object is accomplished by unique steps of the present invention for a method for setting capillary contact position data for a capillary which is set for a particular contact position, the setting being performed at a time when a used capillary is replaced with a new capillary in a wire bonding apparatus; and in the present invention, the method comprise the steps of:
obtaining a clearance difference between, in a vertical direction, a reference member and old (used) and new (unused) capillaries measured respectively before and after capillary replacement, and
setting post-replacement capillary contact position data based on pre-replacement capillary contact position data and the obtained clearance difference.

In this method, the measurement of the clearance difference between the old (used) capillary and reference member and the new (replaced) capillary and reference member can be performed by:
an image capturing device that captures elevation images of the old (used) and new (replaced) capillaries and the reference member; and
a clearance measuring means that processes the elevation images obtained by the image capturing device, and measures the distance in the vertical direction between the tip ends of the old (used) and new (replaced) capillaries and the tip end of the reference member.

In addition, the reference member can be provided with a plane or a line that opposes (faces) and is parallel to the tip end surfaces of the old (used) and new (replaced) capillaries.

The above object is further accomplished by a unique structure of the present invention for a wire bonding apparatus that includes:
a replaceable capillary set for a particular contact position,
a reference member provided in a predetermined position,
an image capturing device for capturing elevation images of the old (used) and new (replaced) capillaries and the reference member,
a clearance measuring means that processes the elevation image obtained by the image capturing device, and measures the distances in a vertical direction between the tip ends of the old (used) and new (replaced) capillaries and the tip end of the reference member, and
a capillary contact position data setting means that sets post-replacement capillary contact position data based on pre-replacement capillary contact position data and a clearance difference between, in the vertical direction, the tip end of the reference member and the tip ends of the old (used) and new (replaced) capillaries measured by the clearance measuring means before and after the capillary replacement.

The present invention provides the benefits of being able to shorten the capillary replacement time and to reduce the labor on maintenance of bonding apparatuses.

### BRIEF DESCRIPTION OF THE SEVERAL VIEWS OF THE DRAWINGS

FIG. 1-1 is an explanatory diagram showing the manner of setting capillary contact position data according to the present invention, and FIG. 1-2 illustrates a bonding apparatus according to the present invention;

FIG. 2-1 and FIG. 2-2 (continued from FIG. 2-1) show the capillary replacement procedures according to the present invention;

FIG. 3(a) and 3(b) illustrate a conventional wire bonding apparatus;

FIG. 4 is a top view of a work on which wire bonding is performed;

FIG. 5 shows the steps of wire bonding in a conventional wire bonding apparatus;

FIG. 6 illustrates the conditions of a used capillary;

FIGS. 7-1 and FIG. 7-2 (continued from FIG. 7-1) shows conventional capillary replacement procedures; and

FIG. 8 illustrates a capillary contact position and the distance of movement.

### DETAILED DESCRIPTION OF THE INVENTION

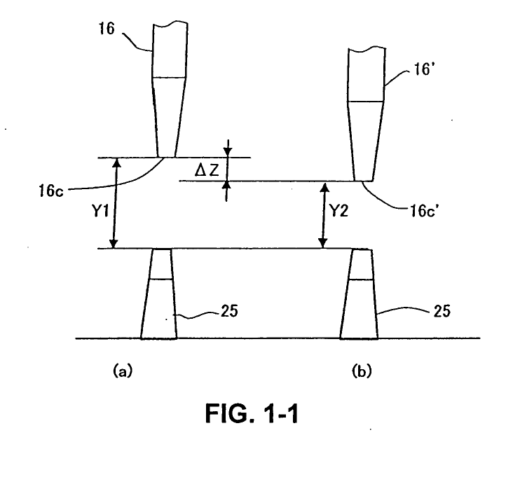

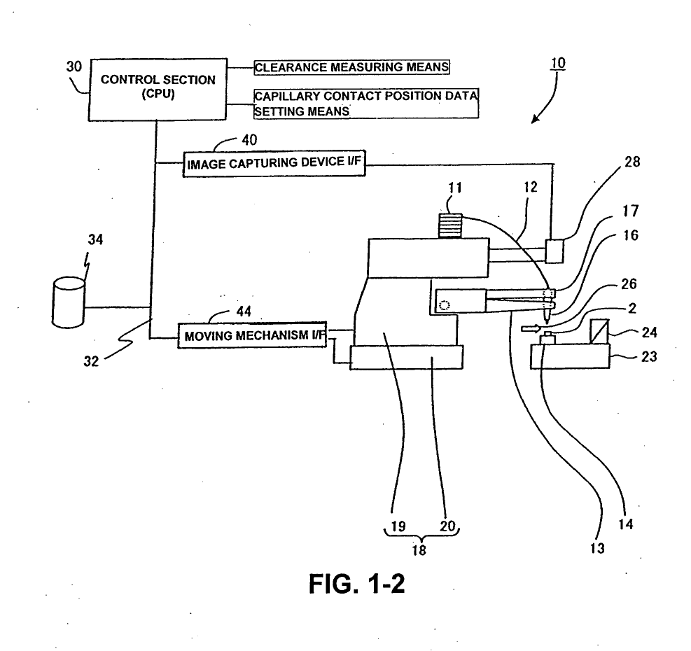

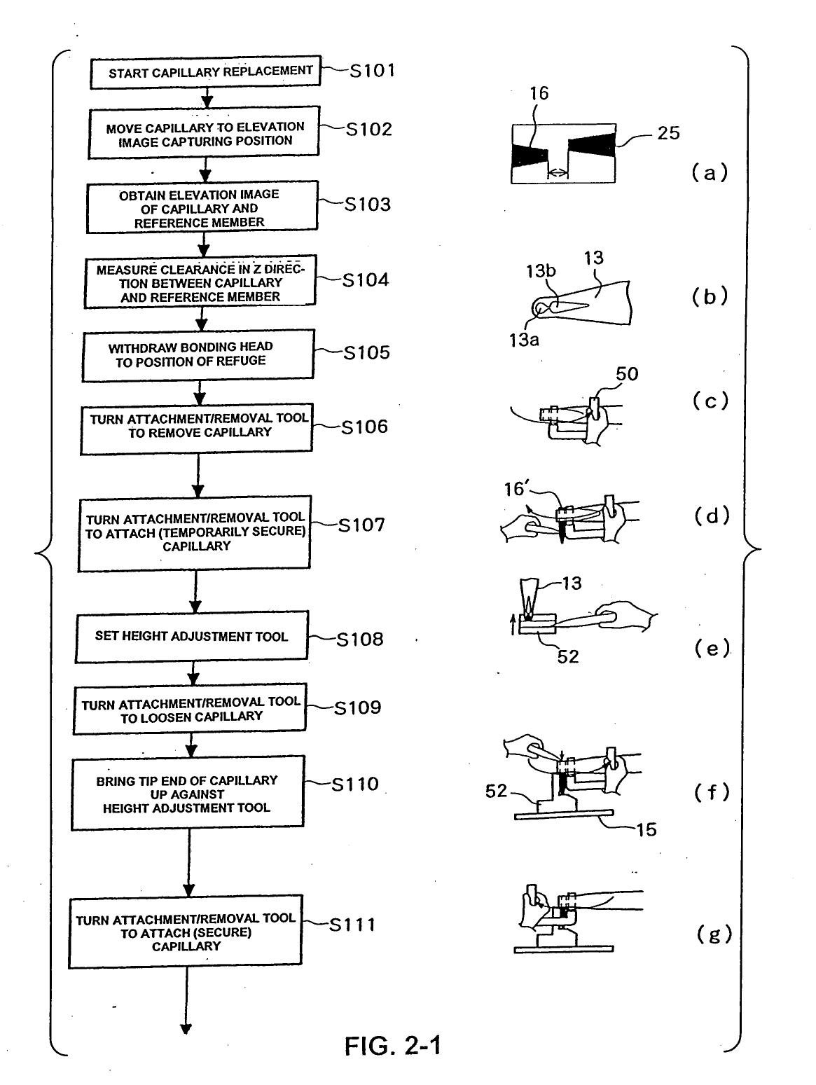

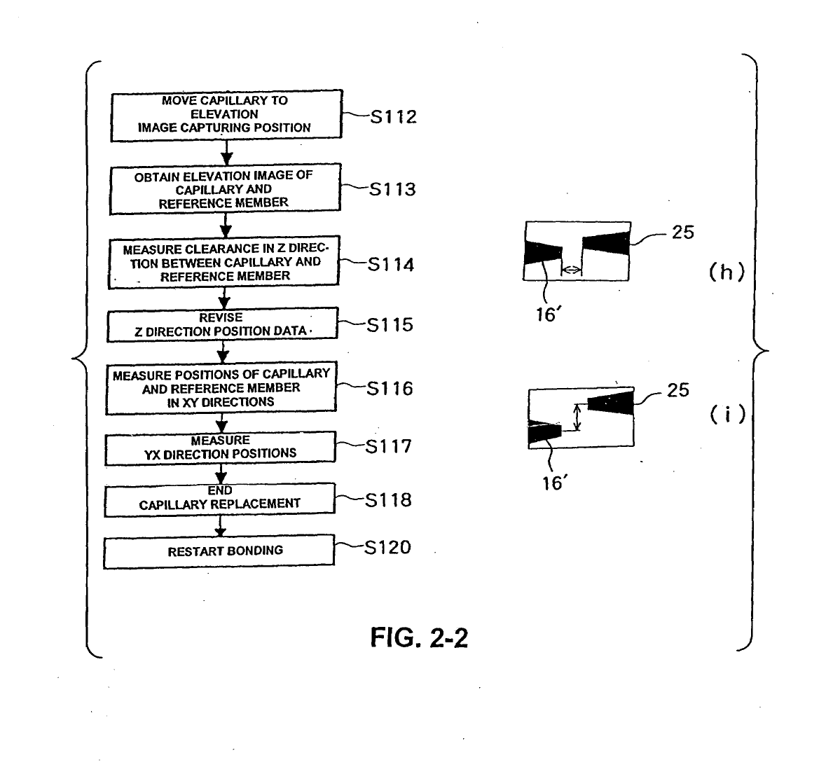

Capillary replacement procedures and the method for setting capillary contact position data of the present invention will be described below with reference to FIGS. 1-1 through FIG. 2. FIG. 1 -1 is an explanatory diagram showing the manner of setting capillary contact position data of the present invention, FIG. 1-2 shows a (wire) bonding apparatus according to the present invention, and FIG. 2 shows the capillary replacement procedures of the present invention. For those that are the same as in the conventional art described above, the same reference numerals are used, and no further description thereof will be provided below.

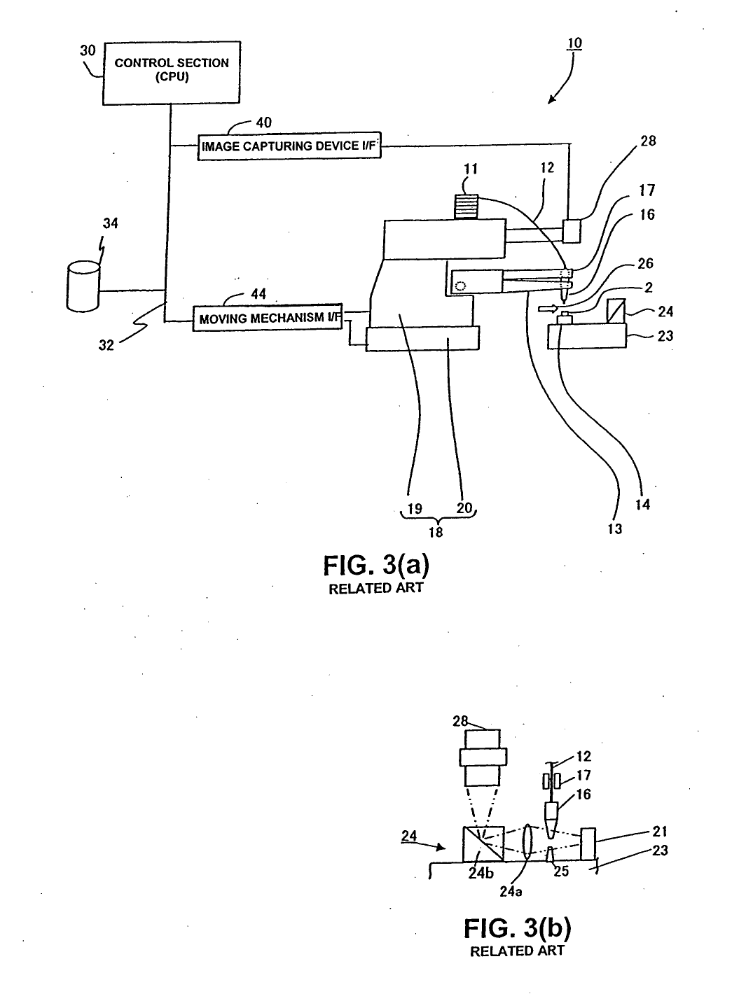

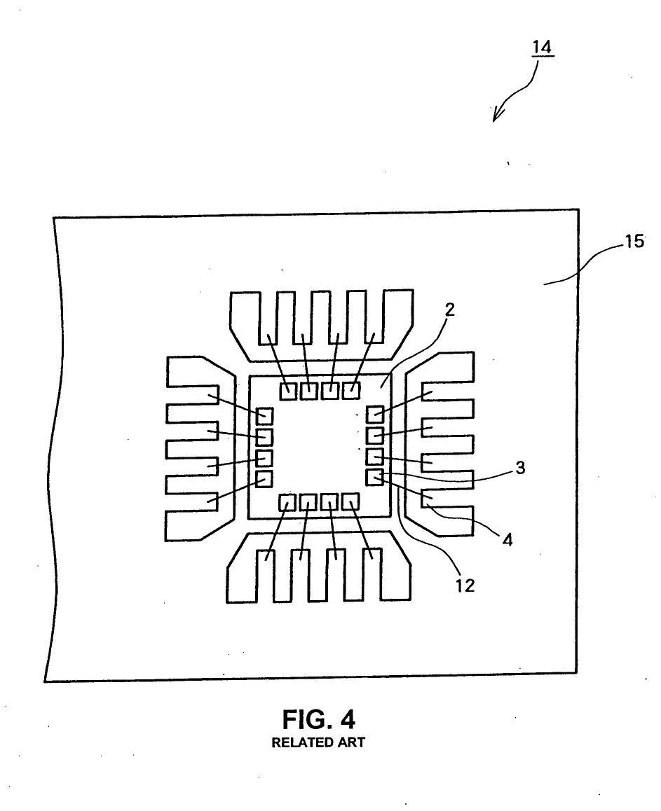

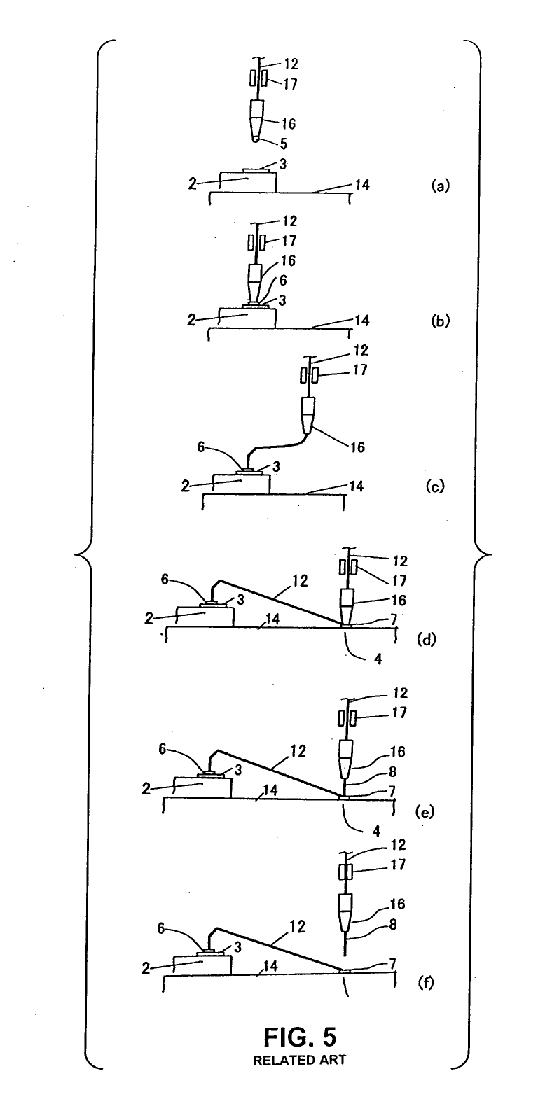

(1) When replacement of capillary is begun, a control section 30 (see FIG. 3) moves (the position of) the used (old) capillary 16 by a moving mechanism 18 to an elevation image capturing position in which the light path device 24 is installed (steps S101 and S102 in FIG. 2).

(2) Elevation image data of the used capillary 16 and the reference member 25 captured by the image capturing device 28 (see FIG. 3) are input into the control section 30 via the image capturing device interface 40.

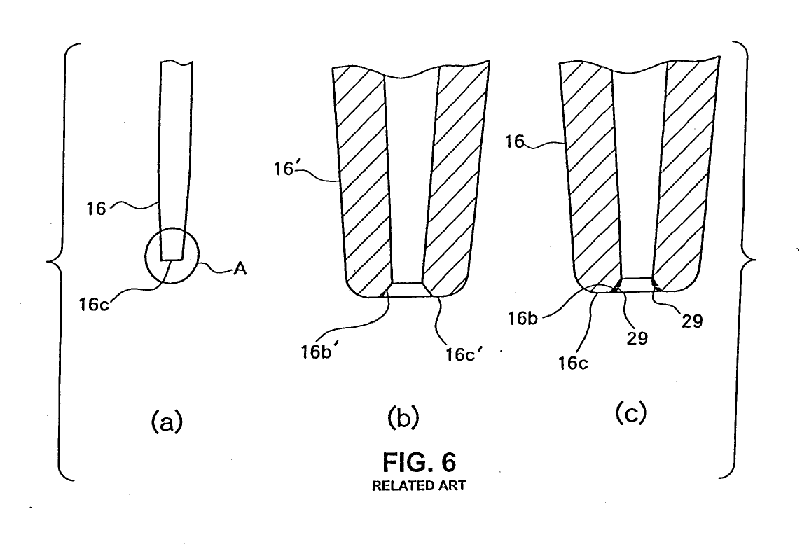

The control section 30 obtains the number of pixels for clearance (distance) between the tip end part of the capillary 16 and the reference member 25 from the input elevation image, and then it processes those data by a clearance measuring means which is a data processing means for effecting clearance measurement and the like, and then it measures the clearance between the tip end 16c of the used capillary 16 and the tip end of the reference member 25. The used capillary 16 has, as shown in illustration (c) of FIG. 6((c) being an enlarged cross-sectional illustration of a circled portion of illustration (a) of FIG. 6), foreign matter 29 adhering to the surface of the chamfered portion 16b in the interior of the capillary; however, there is no adhering substance sticking to the tip end surface 16c of the capillary 16 that is the end surface for pressing the wire against the first bonding point (pad) 3 and second bonding point (lead) 4. For this reason, the tip end surface of the capillary can be recognized in the elevation image even for a used capillary, and it is possible to measure the clearance between the tip end surface of the used capillary 16 and the tip end of the reference member 25 with good precision (steps S103 and S104 in FIG. 2, FIG. 2(a)). In order for the tip end surface of the opposing reference member 25 to be recognized accurately in the elevation image and for the measuring of the clearance between the tip end surface of the capillary 16 and the tip end of the reference member 25 to be performed accurately, the reference member 25 can be formed in a shape that has a plane or a line(s) that opposes or faces and is parallel to the tip end surface of the capillary. With this structure of the reference member 25, it is possible to improve the measurement precision. The clearance Y1, as shown in FIG. 1-1, between the tip end of the reference member 25 and the tip end 16c of the used capillary 16 is input as data (clearance data) into the control section 30((a) in FIG. 1-1).

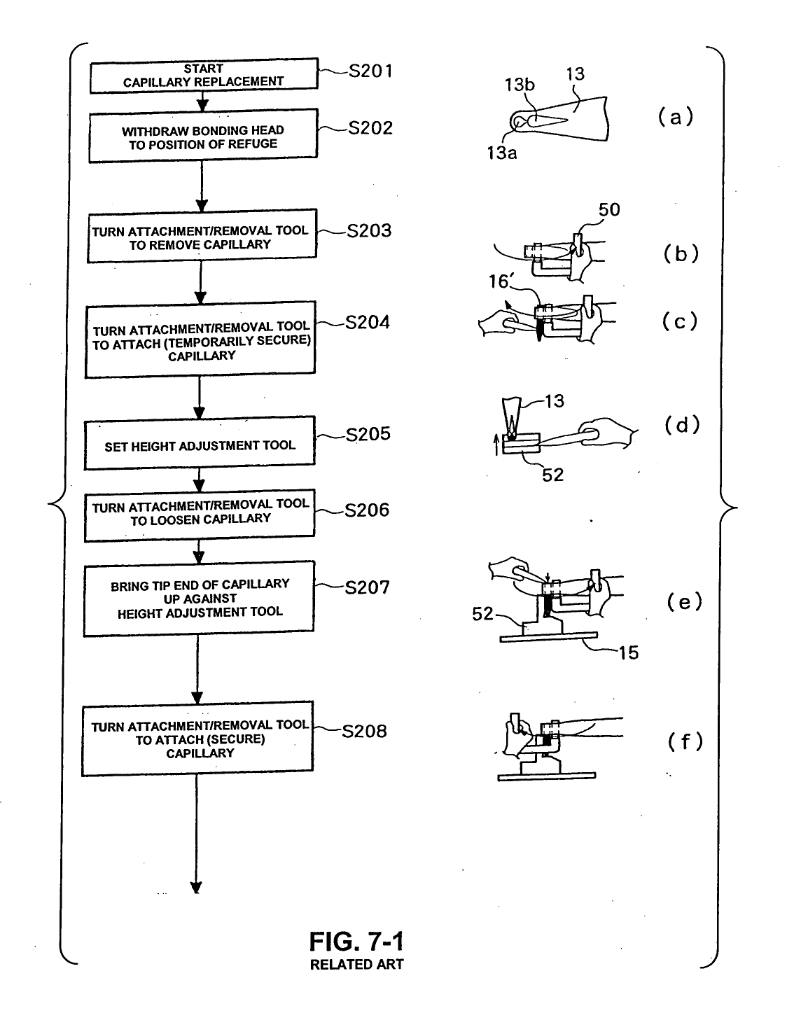

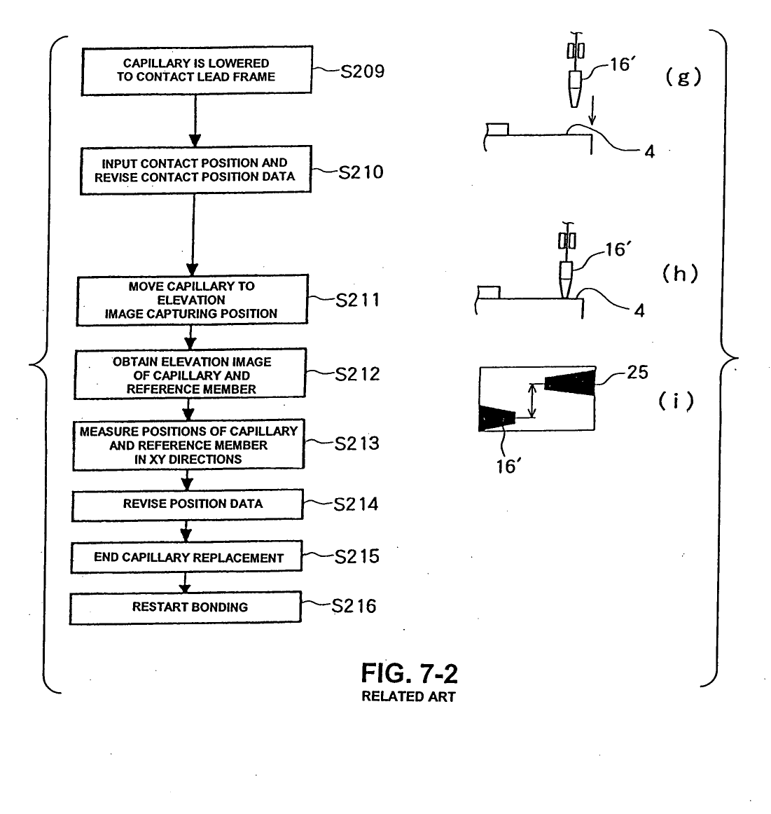

(3) Once the measurement of the clearance between the tip end 16c of the capillary 16 and the tip end of the reference member 25 has finished, the control section 30 withdraws the bonding head 19 to a position of refuge by the moving mechanism 18. Then, the used capillary 16 is manually replaced for a replacement (new) capillary 16′ by the same procedure as in the conventional art (steps S105 to S111 in FIG. 2 that correspond to steps S202 to S208 of FIG. 7, FIG. 2(b) to 2(g) that correspond to FIG. 7(a) to 7(f)).

(4) After changing to the replacement (new) capillary 16′, the control section 30 moves the replaced capillary 16′ to the elevation image capturing position by the moving mechanism 18 (step S112 in FIG. 2).

An elevation image of the replaced capillary 16′ and the reference member 25 is obtained next by the image capturing device 28, and the captured image is input as data into the control section 30 (step S113 in FIG. 2).

The control section 30 processes the input elevation image data and measures the clearance between the reference member 25 and the replaced capillary 16′ (step S114 in FIG. 2, FIG. 2(h)). The clearance Y2, shown in FIG. 1-1, between the tip end of the reference member 25 and the tip end 16c′ of the replaced capillary 16′ is input into the control section 30 as data (clearance data) ((b) in FIG. 1-1).

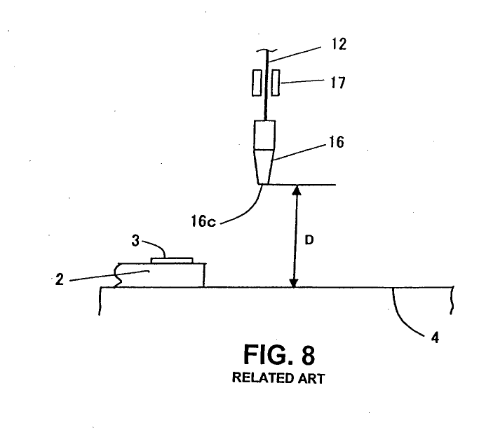

(5) The clearance difference ΔZ between the clearance Y1 between the used (old) capillary 16 and the reference member 25 and the clearance Y2 between the replaced capillary 16′ and the reference member 25 is a numerical value indicative of how much the position of the tip end 16c′ of the capillary 16′ has changed due to the replacement. The clearance difference ΔZ is computed as ΔZ=Y2−Y1. The control section 30, using this value of ΔZ, sets and revises the capillary contact position data by a capillary contact position data setting means (step S115 in FIG. 2). In other words, as shown in FIG. 8, the specific capillary contact position data A of the used (old) capillary 16 (pre-replacement capillary contact position data) are stored as data in the memory unit 34 (see FIG. 3); accordingly, the control section 30 computes capillary contact position data A′ of the new capillary 16′ (post-replacement capillary contact position) by formula A′=A+ΔZ, revises the capillary contact position data A to A′, and stores this in the memory unit 34 as new capillary contact position data.

(6) The control section 30 further processes the elevation image data obtained by the image capturing device 28 to obtain position data, in the X and Y (horizontal) directions, of the reference member 25 and the replaced (new) capillary 16′, and the control section 30 rewrites the capillary position data accordingly (steps S116 and S117 in FIG. 2).

(7) Once data revisions have completed, the control section 30 moves the replaced capillary 16′ to the bonding start position by the moving mechanism 18 and begins wire bonding based upon the capillary contact position data A′ (steps S118 and S120 in FIG. 2).

As seen from the above, according to the shown embodiment of the present invention, the revision and setting of the capillary contact height after the replacement of the capillaries are conducted by the control section 30, such a benefit is realized that the manual work time during the capillary replacement is shortened as compared to the conventional art. This advantages yield a particularly large labor/time savings benefit when operating a plurality of wire bonding apparatuses simultaneously. Furthermore, in the present invention, since it is not necessary to manually recognize the capillary contact position, human error can be prevented, and product quality can be enhanced.

1. A method for setting capillary contact position data for a capillary set for a particular contact position, said setting being performed at a time of replacing capillaries in a wire bonding apparatus, said method comprising the steps of:
obtaining a clearance difference between, in a vertical direction, a reference member and capillaries measured respectively before and after capillary replacement; and
setting post-replacement capillary contact position data based on pre-replacement capillary contact position data and said obtained clearance difference.

2. The method for setting capillary contact position data according to claim 1, wherein a measurement of said clearance difference between said capillary and said reference member is performed by:
an image capturing device for capturing an elevation image including said capillaries and said reference member; and
a clearance measuring means for processing said elevation images obtained by said image capturing device to measure a distance in a vertical direction between said tip ends of said capillaries and a tip end of said reference member.

3. The method for setting capillary contact position data according to claim 1, wherein said reference member is provided with one of an opposite surface and an opposite line, said one being parallel to tip end surfaces of said capillaries.

4. A wire bonding apparatus comprising:
a replaceable capillary set for a particular contact position;
a reference member provided in a predetermined position;
an image capturing device for capturing an elevation image including capillaries and said reference member;
a clearance measuring means for processing said elevation images obtained by said image capturing device to measure a distance in a vertical direction between said tip ends of said capillaries and a tip end of said reference member; and
a capillary contact position data setting means for setting post-replacement capillary contact position data, based on pre-replacement capillary contact position data and a clearance difference between, in said vertical direction, said reference member and said capillaries measured by said clearance measuring means before and after capillary replacement.

5. The wire bonding apparatus according to claim 4, wherein said reference member is provided with one of an opposite surface and an opposite line, said one being parallel to tip end surfaces of said capillaries.
